(19) United States
(12) Patent Application Publication
(10) Pub. No.: US 2020/0224855 A1
(43) Pub. Date: Jul. 16, 2020

(54) System and Method of Magnifying Spatial Coherent Light through an Optical Diffuser

(71) Applicant: Richard Redpath, Cary, NC (US)

(72) Inventor: Richard Redpath, Cary, NC (US)

(21) Appl. No.: 16/246,523

(22) Filed: Jan. 13, 2019

(51) Int. Cl. F21V 13/02; F21V 3/04; A01G 7/04

(52) U.S. Cl. CPC F21V 13/02; A01G 7/045; F21V 3/04

(57) ABSTRACT

The apparatus is designed to maximize the amount of spatial coherence of light directed along a desired trajectory by an optical diffuser. The light optimization device contains a laser, a mirror with hole, and an optical diffuser against the mirror. The aperture enables light to travel through the mirror to the optical diffuser. The mirror reflects light that is internally reflected and refracted back from the optical diffuser traveling along suboptimal trajectories. As such, the reflected light is redirected towards the optical diffuser for increased spatial coherence output directed along a desired trajectory forward.

### FIELD OF THE INVENTION

The present invention relates generally to a laser beam through an optical diffuser that spreads out the beam for high spatial coherence, more particularly a device that increases the amount of spatial coherent light from a laser beam for horticulture. A user of the present invention will be able to manufacture a device which first spreads out a laser beam of coherent light with a diffuser, and then reflects the light that is generated by the internal reflections and refractions of the diffuser traveling along suboptimal trajectories back such that the amount of spatial coherent light toward target horticulture is magnified.

### BACKGROUND OF THE INVENTION

Spatial coherence is a strong correlation (fixed phase relationship) between the electric fields at different locations across the beam profile. For example, within a cross-section of a beam from a laser with diffraction-limited beam quality, the electric fields at different positions oscillate in a totally correlated way, even if the temporal structure is complicated by a superposition of different frequency components. Spatial coherence is the essential prerequisite for transmission holograms which can only be viewed by coherent light such as produced by a laser. The preservation of this coherent light is intended for advance plant growth (e.g., horticulture). To illuminate horticulture with coherent light an optical diffuser is deployed rather than a refractive lens system that would create an unwanted and potentially damaging burn area near the lens system.

Although this method of spreading a laser beam for illumination produces spread light with desired properties of spatial coherence, a significant amount of the light is lost. This loss is due to the fact that a portion of the light is internally reflected back and internally refracted back out of the diffusion material. This practice wastes energy and costs more for a return on the investment for a horticulture system to produce product.

Therefore, the object of the present invention is to employ a mirror to redirect light which would otherwise be lost. The present invention uses an arrangement of components that enable a laser beam to pass through a hole in a mirror to the optical diffuser. Once the beam enters the optical diffuser a portion of the light is directed backwards by the diffuser through internal reflection and refraction. However, because of the mirror the light which would normally be lost is directed back towards the optical diffuser. Using the diffuser to spread the source light, and the mirror to redirect wasted back light, increases the efficiency for the present invention to produce spatial coherence in a safe manner. Prior art of a system used for perceived white light is U.S. Pat. No. 9,683,730 “System and Method of Optimizing White Light” which uses a laser beam, diffuser, and modifying substrate to be excited to produce white light. This prior art system is edited to remove the modifying substrate and discovery was shown that the amount of light is increased with preservation of spatial coherence for a brighter transmission hologram thereby demonstrating more coherent light is available for horticulture use.

### BRIEF DESCRIPTION OF THE DRAWINGS

FIG. 1 is a schematic view of the present invention. Light being generated by the light source passes through the transmission hole, is refracted by the optical diffuser for exit as a Gaussian distribution. A portion of the light is directed back towards the mirror surface and is then redirected towards the optical diffuser.

### DETAIL DESCRIPTIONS OF THE INVENTION

All illustrations of the drawings are for the purpose of describing selected versions of the present invention and are not intended to limit the scope of the present invention.

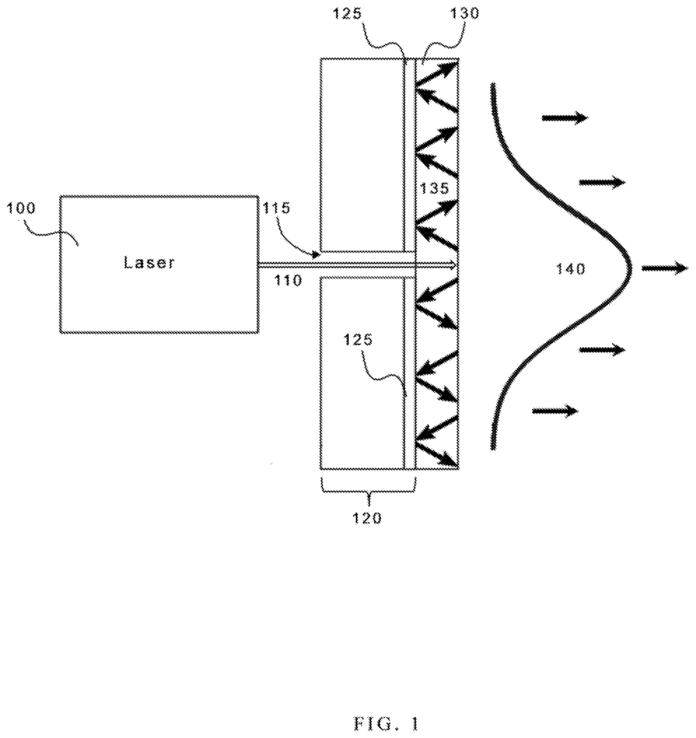

In reference to FIG. 1 at 100 is a laser which produces a beam at 110 that traverses a hole at 115 through a mirror at 120 with mirror surface at 125 facing an optical diffuser at 130. The laser beam at 110 impacts the diffuser at 130 and produces Gaussian light output at 140. At 130 the diffuser has internal reflections and refractions at 135 back to the mirror at 125 which reflects light back through the diffuser at 130.

What is claimed is:

1. A System and Method of Magnifying Spatial Coherent Light through an Optical Diffuser comprises:
a laser beam for coherent light;
the laser beam passing through a transmission hole with back mirrored surface;
an optical diffuser in contact with the back mirrored surface.

2. The System and Method of Magnifying Spatial Coherent Light through an Optical Diffuser as claimed in claim 1 comprises:
a coherent light source;
an emission axis of the light source being collinearly aligned with the transmission hole with back mirrored surface;
the emission axis of the light source being oriented towards the optical diffuser in contact with the mirrored surface.
